(19) United States
(12) Patent Application Publication
(10) Pub. No.: US 2026/0202665 A1
(43) Pub. Date: Jul. 16, 2026

(54) LIGHT GUIDE ELEMENT, OBSERVATION OPTICAL SYSTEM, AND DISPLAY APPARATUS

(71) Applicant: CANON KABUSHIKI KAISHA, Tokyo (JP)

(72) Inventors: Ryo NOZAKI, Tokyo (JP); Keiichiro ISHIHARA, Saitama (JP)

(21) Appl. No.: 19/367,907

(22) Filed: Oct. 24, 2025

(30) Foreign Application Priority Data
Nov. 14, 2024 (JP) 2024-199180

(51) Int. Cl. G02B 27/00; G02B 27/01; G02B 27/09

(52) U.S. Cl. CPC G02B 27/0081; G02B 27/0018; G02B 27/0977; G02B 27/0172

(57) ABSTRACT

A light guide element includes an expander configured to expand incident light, and a light guide unit configured to guide light expanded by the expander to an eyepoint. The expander includes a first reflector and a second reflector. Each of the first and second reflectors has a plurality of reflective surfaces. In a first cross section including the first and second reflectors, the first and second reflectors form angles with different signs from a first axis corresponding to a principal ray at a central angle of view of the incident light. In each of the first and second reflectors, a reflective surface of the plurality of reflective surfaces closest to the light guide unit is a partially reflective surface. Light reflected multiple times by at least one of the first and second reflectors reaches the light guide unit.

### BACKGROUND

### Field of the Technology

The aspect of the disclosure relates to one or more embodiments of a light guide element, an observation optical system, and a display apparatus.

### Description of the Related Art

Observation optical systems having a half-mirror laminated type light guide plate have been known for use in Augmented Reality (AR) glasses and the like. Generally, an image light beam from a display element is small, and to ensure the size of the Eye Motion Box (EMB) over a wide angle-of-view range, the light guide plate has an expander (expansion unit) configured to expand the image light beam.

Japanese Patent Application Laid-Open No. 2015-106105 discloses an expander configured to expand an image light beam by introducing the image light beam into an area where a partial transmission reflective surface and a high-reflectance reflective surface are arranged adjacent and parallel to each other, and repeating reflection and transmission between them. Japanese Patent Application Laid-Open No. 2023-103432 discloses an expander configured to expand an image light beam by arranging a plurality of partial reflective surfaces angled relative to a surface within a waveguide having two parallel surfaces, and repeating total reflection at the surfaces and reflection from the partial reflective surfaces.

### SUMMARY

A light guide element according to one aspect of the disclosure includes an expander configured to expand incident light, and a light guide unit configured to guide light expanded by the expander to an eyepoint. The expander includes a first reflector and a second reflector. Each of the first and second reflectors has a plurality of reflective surfaces. In a first cross section including the first and second reflectors, the first and second reflectors form angles with different signs from a first axis corresponding to a principal ray at a central angle of view of the incident light. In each of the first and second reflectors, a reflective surface of the plurality of reflective surfaces closest to the light guide unit is a partially reflective surface. Light reflected multiple times by at least one of the first and second reflectors reaches the light guide unit. An observation optical system and a display apparatus each having the above light guide element also constitute another aspect of the disclosure.

Features of the disclosure will become apparent from the following description of embodiments with reference to the attached drawings. The following description of embodiments will be described by way of example.

### BRIEF DESCRIPTION OF THE DRAWINGS

FIG. 1 is a schematic diagram of a display apparatus according to each embodiment.

FIG. 2A is a schematic diagram of a light guide plate according to a comparative example.

FIGS. 2B and 2C are schematic diagrams of a light guide plate according to a first embodiment.

FIGS. 3A, 3B, 3C, and 3D illustrate a relationship between the arrangement angle of a mirror pair and propagating light, and explain the arrangement angle of the mirror pair in the first embodiment.

FIGS. 4A, 4B, and 4C are schematic diagrams of a light guide plate according to a second embodiment, and optical path diagrams of light propagating inside the mirror pairs in the first and second embodiments.

FIGS. 5A and 5B are schematic diagrams of a light guide plate and explain the effect of the light guide plate in the second embodiment.

FIG. 6A is a schematic diagram of a light guide plate according to a third embodiment.

FIGS. 6B, 6C, and 6D illustrate an example of reflectance and transmittance in the third embodiment.

FIG. 7A is a schematic diagram of a light guide plate according to a fourth embodiment.

FIG. 7B illustrates an optical path in a thickness direction of the light guide plate and the intensity of an expanded light beam in the third embodiment.

FIGS. 7C and 7D illustrate an optical path in a thickness direction of a light guide plate and the intensity of an expanded light beam in the fourth embodiment.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

### First Embodiment

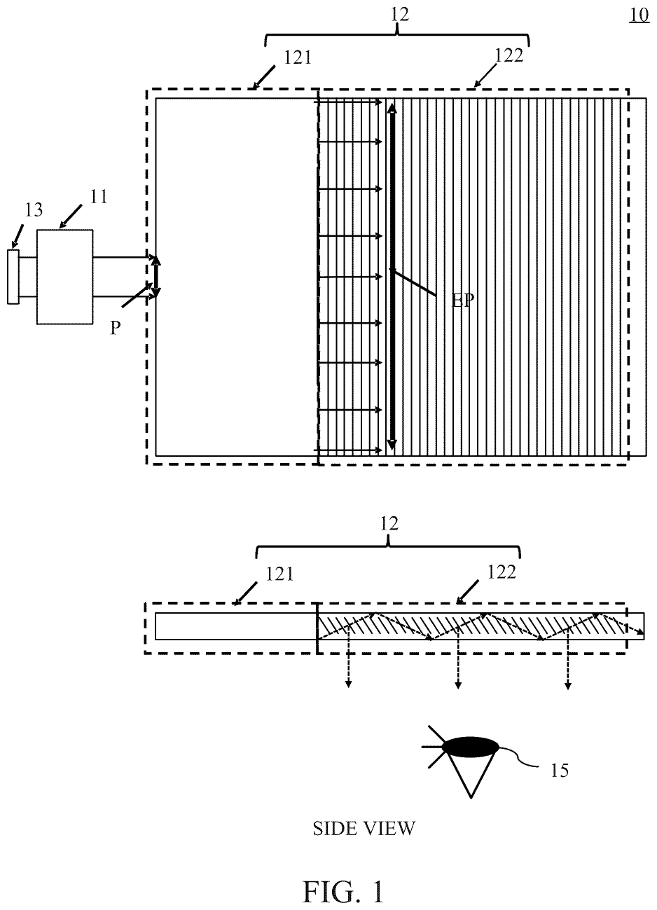

First, a display apparatus 10 according to a first embodiment of the disclosure will be described with reference to FIG. 1. FIG. 1 is a schematic diagram of the display apparatus 10. As illustrated in the upper diagram of FIG. 1, the display apparatus 10 includes a display element 13, a projection optical system (projection unit) 11, and a light guide plate (light guide element) 12 configured to guide an image light beam from the projection optical system 11 to an observer's eye (eyepoint corresponding to the pupil of the observer's eye) 15.

As illustrated in the lower diagram of FIG. 1 (a side view of the light guide plate 12), a light beam entering the light guide plate 12 from the projection optical system 11 (the incident light from the projection optical system 11) travels through the light guide plate 12 while being internally reflected throughout substantially the entire thickness direction of the light guide plate 12 (the vertical direction in the side view). An angle of the light beam emitted from the light guide plate 12 in the width direction of the light guide plate 12 corresponds to a vertical direction and an angle of the light beam emitted from the light guide plate 12 in the thickness direction of the light guide plate 12 corresponds to a horizontal direction.

The light guide plate 12 includes an expander 121 configured to expand light (incident light) from the projection optical system 11 with an image light beam diameter P to light with a predetermined light beam diameter EP, and an emitter (light guide unit) 122 configured to emit (extract) the light (image light beam) expanded by the expander 121 from the light guide plate 12 and guide it to the observer's eye 15.

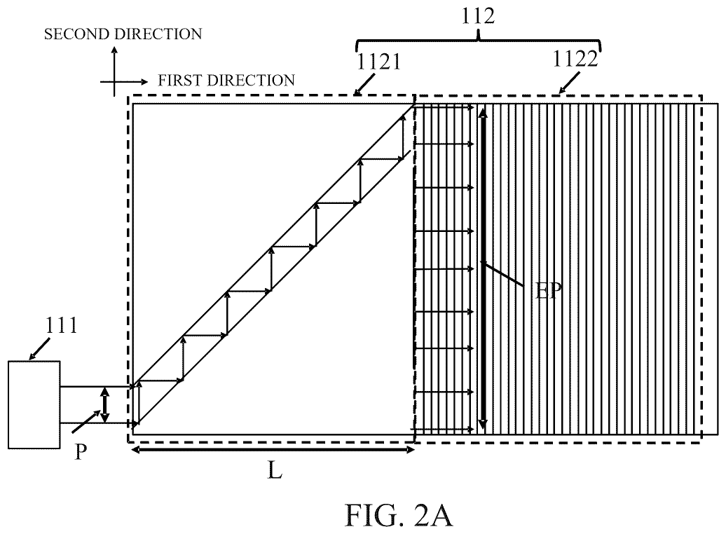

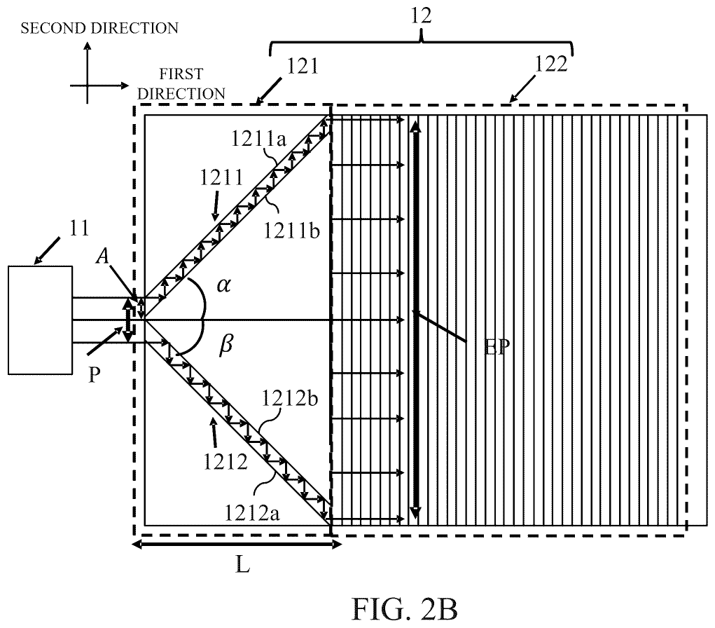

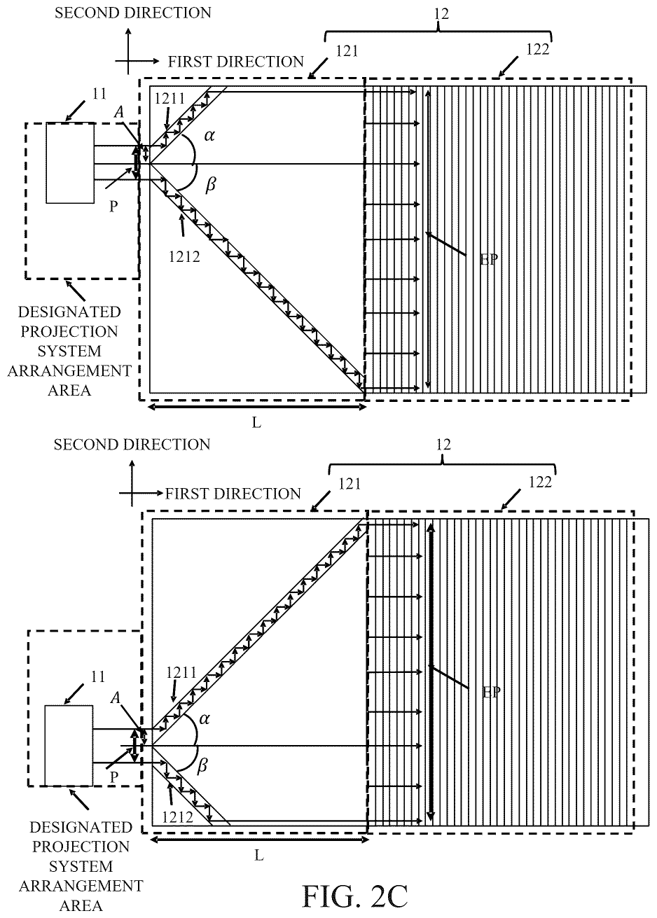

Next, with reference to FIGS. 2A, 2B, and 2C, the functions and effects of the light guide plate 12 according to this embodiment will be described. In the following description, when the light guide plate 12 is observed parallel to the surface of the light guide plate 12, the traveling direction of the central angle of view ray of the image light beam (the principal ray at the central angle of view of the incident light on the light guide plate 12) is defined as an X-axis direction (a direction of the first axis, the first direction). Here, the principal ray is a light ray that passes through the center of the aperture in the aperture stop (the light ray that passes through the center of the pupil). A direction orthogonal to the X-axis direction is a Y-axis direction (direction of the second axis, second direction), and a direction orthogonal to the X-axis and Y-axis (direction from the observer's eye 15 toward the light guide plate 12) is a Z-axis direction.

FIG. 2A is a schematic diagram of a light guide plate 112 according to a comparative example, illustrating an expander 121 in which one pair of adjacent parallel mirrors (two mirrors) are arranged at a predetermined angle relative to the first direction. Length L of the expander 121 required to expand the light to a predetermined light beam diameter EP is determined by an angle at which the mirror pair is arranged. Hence, the projection optical system 111 may be disposed at the end of the light guide plate 112.

FIGS. 2B and 2C are schematic diagrams of the light guide plate 12 according to this embodiment. As illustrated in FIG. 2B, the expander 121 of the light guide plate 12 has adjacent parallel mirror groups (mirror units or mirror pairs) 1211 and 1212 arranged at two angles (first angle) a and angle (second angle) β relative to the first direction. The mirror group 1211 serves as a first reflector having a plurality of reflective surfaces, and the mirror group 1212 serves as a second reflector having a plurality of reflective surfaces.

Here, the angles α and β are angles that are opposite to each other relative to the propagation direction (first direction) of the principal ray at the central angle of view of the incident light, i.e., the incident direction of light (central axis) passing through the center of the pupil, in a predetermined cross section (first cross section). Here, the first cross section is a cross section that includes the mirror groups 1211 and 1212 (a cross section that includes the first axis and the second axis), as illustrated in FIG. 2B. That is, the mirror groups 1211 and 1212 form angles with opposite signs relative to the first axis that corresponds to the principal ray at the central angle of view of the incident light in the first cross section.

In each embodiment, the clockwise direction from the principal ray is defined as a positive direction, and the counterclockwise direction from the principal ray is defined as a negative direction. The angles α and β (°) are set within ranges that satisfy the following inequalities:

$$\begin{matrix}- 90 < α \\ β < 0 \\ 0 < α , β < 90 .\end{matrix}$$

That is, the absolute values |α| and |β| (°) of the angles α and β, respectively, satisfy the following inequality:

$$0 < \vert α \vert and \vert β \vert < 90 .$$

The absolute values of the angles α and β may be less than 45°; that is, the following inequalities may be satisfied:

$$\begin{matrix}0 < \vert α \vert < 45 \\ 0 < \vert β \vert < 45.\end{matrix}$$

The image light beam reaches the emitter 122 after it is reflected a plurality of times between the two mirrors that make up the mirror group 1211 or 1212. The width of each mirror surface of the mirror group 1211 or 1212 is approximately the same as the thickness of the light guide plate 12. A distance A in the second direction between the two mirrors that make up each mirror group 1211 or 1212 is less than half the image light beam diameter P.

The plurality of reflective surfaces of each mirror group 1211 or 1212 have different reflectances. In this embodiment, the plurality of reflective surfaces include a first surface with a first reflectance and a second surface with a second reflectance that is lower than the first reflectance. That is, the mirror group 1211 has mirrors (reflective surfaces) 1211a with the first reflectance and mirrors 1211b with the second reflectance. Similarly, the mirror group 1212 has mirrors 1212a with the first reflectance and mirrors 1212b with the second reflectance.

Of the two mirrors 1211a and 1211b that make up the mirror group 1211, the mirror farther (or farthest) from the emitter 122 has a reflective surface with a reflectance of 90% or more. Similarly, of the two mirrors 1212a and 1212b that make up the mirror group 1212, the mirror farther (or farthest) from the emitter 122 (the farthest mirror) has a reflective surface with a reflectance of 90% or more.

On the other hand, of the two mirrors 1211a and 1211b that make up the mirror group 1211, the mirror 1211a that is closer to the emitter 122 (i.e., the mirror closest to the emitter 122) is a partially reflective surface (partially transmissive reflective surface). Similarly, of the two mirrors 1212a and 1212b that make up the mirror group 1212, the mirror 1212b that is closer to the emitter 122 (i.e., the mirror closest to the emitter 122) is also a partially reflective surface (partially transmissive reflective surface). Hence, the image light beam is reflected multiple times by each of the mirror groups 1211 and 1212, expanding its beam diameter as it travels in the first direction. Due to this configuration, the length L in the first direction of the expander 121 for expanding the beam to a predetermined light beam diameter EP can be shorter than that using only a single mirror group (mirror pair), as in the comparative example illustrated in FIG. 2A.

The reflective surface (such as the mirrors 1211a and 1212a) is a surface with a light reflectance of 90% or more. The reflective surface may be a surface with a reflectance of 95% or more. On the other hand, the partially reflective surface (such as the mirrors 1211b and 1212b) is a surface with a lower reflectance than the reflective surface (such as the mirrors 1211a and 1212a), i.e., a surface with a reflectance of less than 95%. The partially reflective surface may be a surface with a reflectance of 3% or more and less than 90%. The partially reflective surface may be a surface with a reflectance of 5% or more and less than 80%. These points are similarly applied to the following embodiments. A partially reflective surface is sufficient as long as at least a part of the surface is a transmissive reflective surface, and may be configured so that only a part of the surface is a transmissive reflective surface, or so that the entire surface is a transmissive reflective surface.

In this embodiment, the position of the projection optical system 11 can be adjusted arbitrarily according to the lengths of the two mirror groups 1211 and 1212. Therefore, as illustrated in FIG. 2C, the projection optical system 11 can be disposed in a projection system arrangement area designated for the display apparatus 10 from a design perspective. In other words, this embodiment can improve the degree of freedom in positioning the projection optical system 11.

The angles α and β (°) may satisfy the following inequalities (1-1) and (1-2):

$$\vert α \vert - \vert φ \vert / 2 < 45 \qquad ( 1 - 1 )$$

$$\vert β \vert - \vert φ \vert / 2 < 45 \qquad ( 1 - 2 )$$

where |φ| (°) is an angle relative to the first direction of an angle-of-view ray contained in the image light beam.

The angles α and β (°) may satisfy the following inequalities (2-1) and (2-2):

$$\vert α \vert - \vert {φ}_{M} \vert / 2 < 45 \qquad ( 2 - 1 )$$

$$\vert β \vert - \vert {φ}_{M} \vert / 2 < 45 \qquad ( 2 - 2 )$$

where |φ_{M}| (°) is a maximum angle between the angle-of-view ray contained in the image light beam and the first direction.

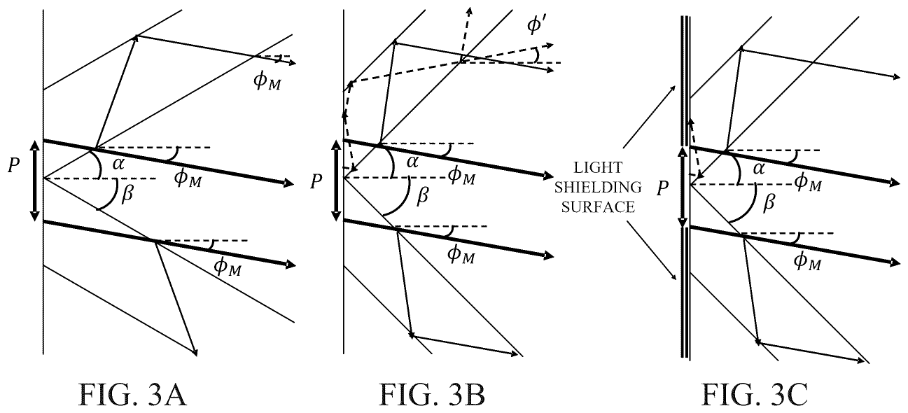

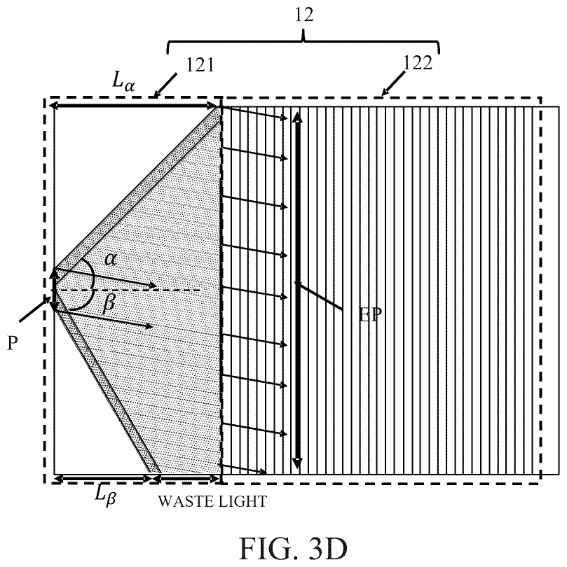

FIGS. 3A, 3B, and 3C illustrate a relationship between the mirror pair arrangement angle and propagating light in this embodiment. FIG. 3D explains the mirror pair arrangement angle in this embodiment. In a case where inequalities (2-1) and (2-2) are not satisfied, as illustrated in FIG. 3A, part of light incident on the partially reflective surface is totally reflected by the side surface of the light guide plate 12 and becomes a light ray propagating at an angle q′ different from the original angle-of-view ray. A light ray that reaches the emitter 122 is guided to the observer's eye 15 as ghost light, and may degrade the quality of the displayed image.

On the other hand, in a case where inequalities (2-1) and (2-2) are satisfied, as illustrated in FIG. 3B, no light rays are totally reflected by the side surface of the light guide plate 12, and therefore no ghost light is generated. In a case where it is difficult to satisfy inequalities (2-1) and (2-2) due to size constraints on the light guide plate 12, the side surfaces of the light guide plate 12 (at least a part of the side surfaces of the light guide plate 12) excluding the incident part of the image light beam may be light-shielding surfaces, as illustrated in FIG. 3C. This configuration can absorb totally reflected light and suppress the occurrence of ghosts.

In this embodiment, the angles α and β may be equal to each other. The length L (L_{β}, L_{β}) of the expander 121 required to expand light (incident light) with an image light beam diameter P from the projection optical system 11 to light with a predetermined light beam diameter EP depends on the angles φ_{M}, α, and β. In a case where the angles α and β are not equal to each other, as illustrated in FIG. 3D, light will reach the side surfaces of the light guide plate 12 before reaching the emitter 122, and become light that is absorbed or totally reflected (waste light). This may reduce the propagation efficiency of the image light beam.

This embodiment can provide a light guide element, an observation optical system, and a display apparatus, each of which has a reduced size and can suppress the occurrence of ghosts. The conditions described in this embodiment are also applicable to the embodiments described later.

### Second Embodiment

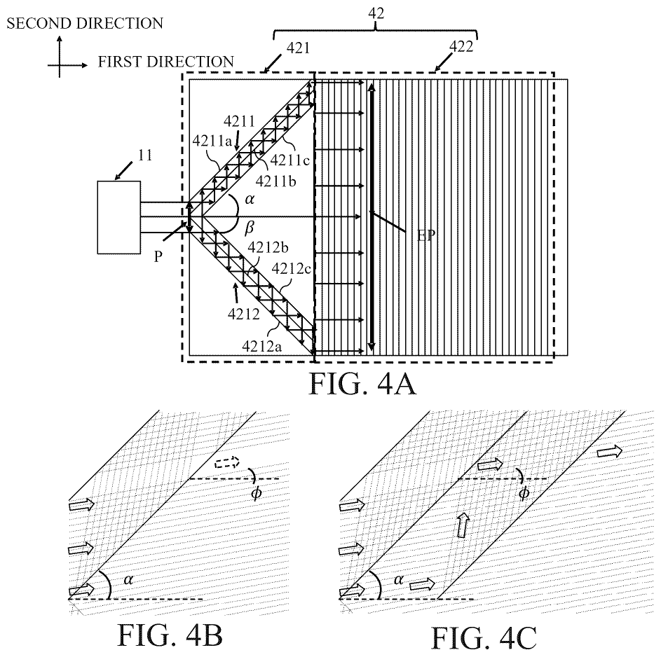

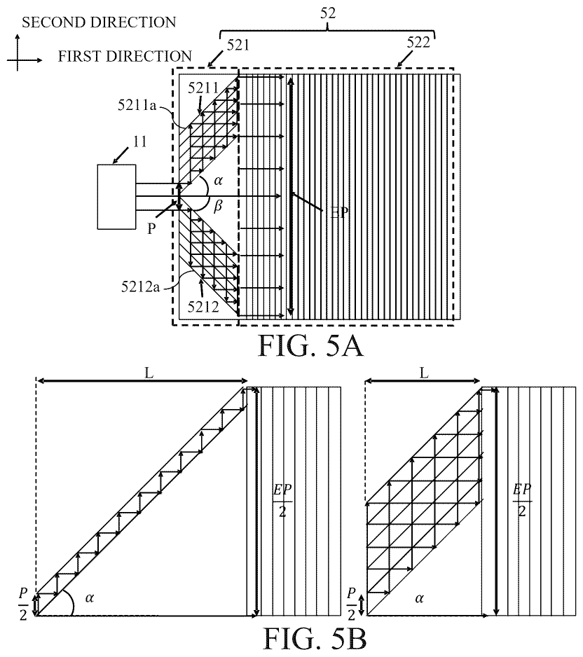

Next, a second embodiment of the disclosure will be described with reference to FIGS. 4A, 4B, 4C, 5A, and 5B. FIG. 4A is a schematic diagram of a light guide plate (light guide element) 42 according to this embodiment. FIG. 4B illustrates an optical path of light propagating inside the mirror group 1211 (1212) in the first embodiment. FIG. 4C illustrates an optical path of light propagating inside the mirror group 4211 (4212) in this embodiment. FIG. 5A is a schematic diagram of a light guide plate (light guide element) 52 according to a variation of this embodiment. FIG. 5B explains the effects of the light guide plate 52.

In the first embodiment, each of the mirror groups 1211 and 1212 has only one partially reflective surface (partially transmissive reflective surface). On the other hand, in this embodiment, each mirror group has a plurality of partially reflective surfaces in at least one of the first and second directions.

First, the light guide plate 42 in this embodiment will be described with reference to FIG. 4A. The light guide plate 42 includes an expander 421 and an emitter 422. The expander 421 includes a mirror group (first reflector) 4211 and a mirror group (second reflector) 4212 arranged at angles α and β on opposite sides of the first direction. The mirror group 4211 has three adjacent, parallel mirrors (reflective surfaces) 4211a, 4211b, and 4211c along the first direction. Similarly, the mirror group 4212 has three adjacent, parallel mirrors (reflective surfaces) 4212a, 4212b, and 4212c along the first direction. Of the three mirrors 4211a, 4211b, and 4211c, two mirrors 4211b and 4211c, except for the mirror 4211a, which is farthest from the emitter 422, are partially transmissive reflective surfaces. Similarly, of the three mirrors 4212a, 4212b, and 4212c, the other two mirrors, 4212b and 4212c, except for mirror 4212a, which is farthest from the emitter 422, are partial transmissive reflective surfaces.

In this embodiment, although each of the mirror groups 4211 and 4212 includes three mirrors, each of them may have four or more mirrors. Even in this case, all of the mirrors except for the mirror farthest from the emitter 422 are partial transmissive reflective surfaces.

FIG. 4B illustrates an optical path of a light beam in which an angle of an angle-of-view ray contained in an image light beam relative to the first direction is q in a case where only one partial transmissive reflective surface is provided, as in the first embodiment. As such, for light rays other than the central angle of view, gaps appear in the expanded light beam, and gaps of an equivalent size also appear in the light beam guided to the observer's eye 15. As the angle φ increases, the gaps increase and become noticeable to the observer, leading to a decrease in image quality.

On the other hand, FIG. 4C illustrates an optical path in a case where a plurality of partial transmissive reflective surfaces are provided, as in this embodiment. Since light reflected by the partially transmissive reflective surface closer to the emitter 422 travels along an optical path that fills the gap, the light beam can be expanded without creating a gap, even if the angle φ increases.

As described above, in this embodiment, the plurality of mirrors that make up each of the mirror groups 4211 and 4212 include at least three mirrors arranged along the first direction. All of the plurality of mirrors except for the mirror farthest from the emitter 422 are partially reflective surfaces.

Next, with reference to FIG. 5A, the light guide plate 52 according to the variation of this embodiment will be described. The light guide plate 52 includes an expander 521 and an emitter 522. The expander 521 includes a mirror group (first reflector) 5211 and a mirror group (second reflector) 5212 that are arranged on opposite sides of each other at angles α and β relative to the first direction. The mirror group 5211 has six adjacent, parallel mirrors (reflective surfaces) arranged along the second direction. Similarly, mirror group 5212 has six adjacent, parallel mirrors (reflective surfaces) along the second direction. Of the six mirrors in each of the mirror groups 5211 and 5212, the other five mirrors, except for mirror 5211a (5212a), which is farthest from the incident part of the image light beam, are partially transmissive reflective surfaces. As illustrated in FIG. 5B, this configuration can reduce the length L of the expander 121 in FIG. 2B, and the size of the light guide plate 52.

In this variation, each of the mirror groups 5211 and 5212 has six mirrors, but may have three or more mirrors. Even in this case, all of the mirrors other than the mirror farthest from the incident part of the image light beam are partially transmissive reflective surfaces.

As described above, in this variation, the plurality of mirrors that make up each of the mirror groups 5211 and 5212 include at least three mirrors arranged along the second direction orthogonal to the first direction. All of the plurality of mirrors except for the mirror farthest from the incident part of the incident light of the expander 521 are partially reflective surfaces.

This embodiment has discussed the effects of arranging a plurality of partially reflective surfaces in the first or second direction separately. Placing a plurality of partially reflective surfaces in both the first and second directions can simultaneously achieve both effects. Thus, placing the plurality of partially transmissive reflective surfaces can provide a light guide element, an observation optical system, and a display apparatus, each of which has a reduced size and can suppress the occurrence of ghosts, even over a wide angle of view.

### Third Embodiment

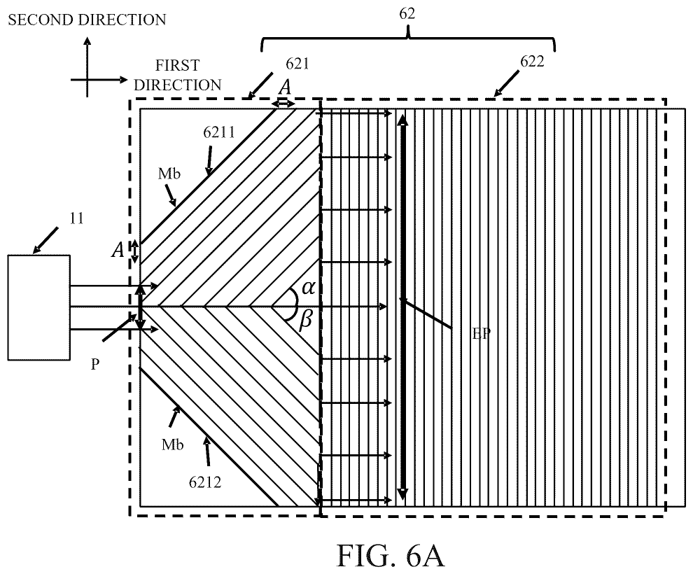

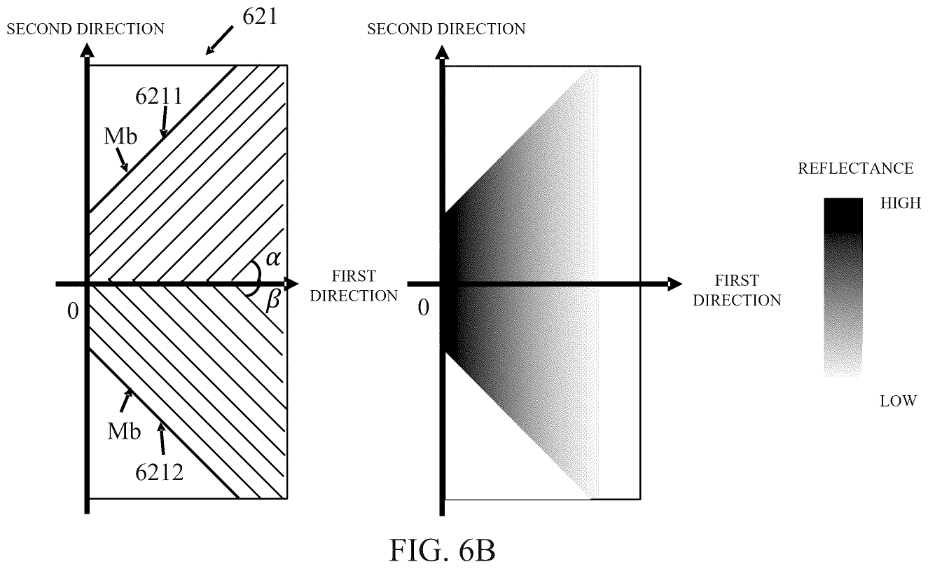

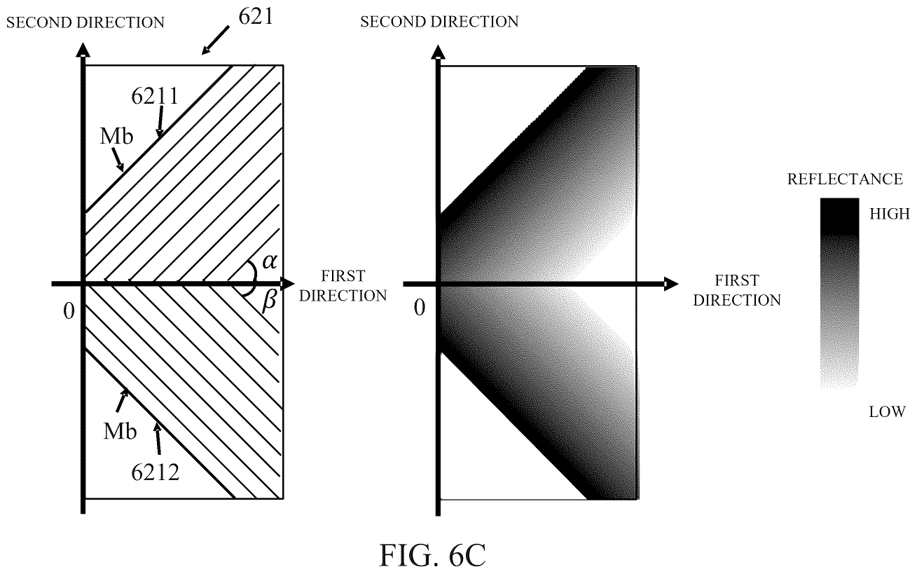

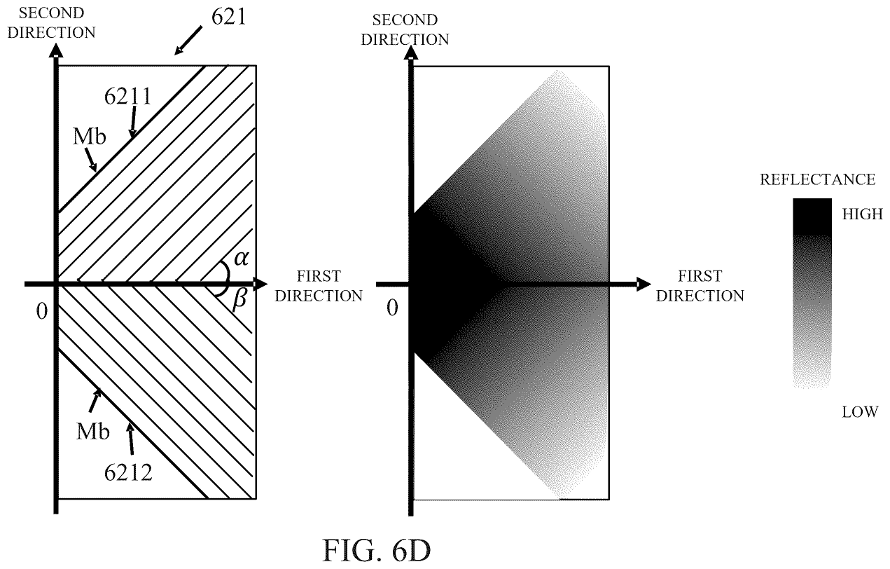

Next, a third embodiment of the disclosure will be described with reference to FIGS. 6A, 6B, 6C, and 6D. FIG. 6A is a schematic diagram of a light guide plate (light guide element) 62 according to this embodiment. FIGS. 6B, 6C, and 6D illustrate examples of the reflectance and transmittance of the partially reflective surfaces (partially transmissive reflective surfaces) of the mirror group in this embodiment. This embodiment differs from the first and second embodiments in that the transmittance and reflectance of the partially reflective surface vary between mirrors, within the same mirror surface, or both, according to the position of the partially reflective surface.

First, with reference to FIG. 6A, the light guide plate 62 according to this embodiment will be described. The light guide plate 62 includes an expander 621 and an emitter 622. The expander 621 has a mirror group (first reflector) 6211 and a mirror group (second reflector) 6212 that are arranged on opposite sides of the first direction at angles α and β. Each of the mirror groups 6211 and 6212 has a plurality of adjacent parallel mirrors along each of the first and second directions. The distance between two adjacent mirrors (mirror distance) is set to less than half the diameter P of the incident image light beam. However, this embodiment is not limited to this example, and the mirror distance in each of the first and second directions may be different.

In each of the mirror groups 6211 and 6212, all mirrors except for the mirror Mb, which is farthest in the second direction from the incident part of the image light beam, are partially reflective surfaces (partially transmissive reflective surfaces). The transmittance and reflectance of the partially reflective surface are set to vary between mirrors, within the same mirror surface, or both, according to the position within the expander 621. The change in transmittance and reflectance can be achieved with a single type of coating, for example, by defining it as an area ratio between a mirror coated portion and an uncoated portion on the mirror surface.

A description will now be given of the change in transmittance and reflectance of the partially reflective surfaces. First, as illustrated in FIG. 6B, within the expander 621, the reflectance may change so as to decrease along the first direction. That is, the reflectance of the partially reflective surface may decrease as the distance from the projection optical system 11 in the first direction increases.

Since many areas of the expanded light beam (light beam with a predetermined light beam diameter EP) utilize light reflected near the incident part of the image light beam, increasing the reflectance near the incident part can reduce the difference in light intensity with areas that utilize transmitting light. On the other hand, reducing the reflectance near the emitter 622 can increase a light amount reaching the emitter 622.

For the similar reasons, in a case where a plurality of partially reflective surfaces are provided, the reflectance may decrease as the distance from mirror Mb increases, as illustrated in FIG. 6C. That is, the plurality of mirrors include a first partially reflective surface and a second partially reflective surface that is closer to emitter 622 than the first partially reflective surface, and the reflectance of the first partially reflective surface may be higher than the reflectance of the second partially reflective surface. In a case where a plurality of partially reflective surfaces are provided, the reflectance may decrease within the same mirror surface as the distance from the incident part of the image light beam increases, as illustrated in FIG. 6D. That is, the reflectance of each of the first and second partially reflective surfaces may decrease as the distance from the projection optical system 11 increases. The changes in the transmittance and reflectance of the partially reflective surfaces can have a higher effect by setting a combination of the respective results.

Hence, changing the transmittance and reflectance of the partially reflective surface between mirrors, within the same mirror, or both, according to the position within the expander 621 can expand the light beam and suppress the unevenness.

### Fourth Embodiment

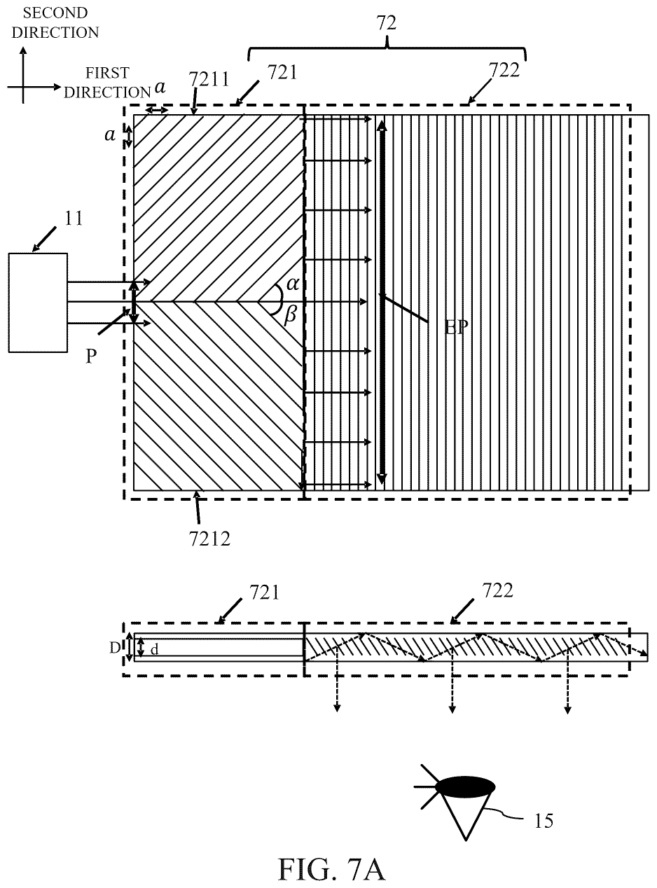

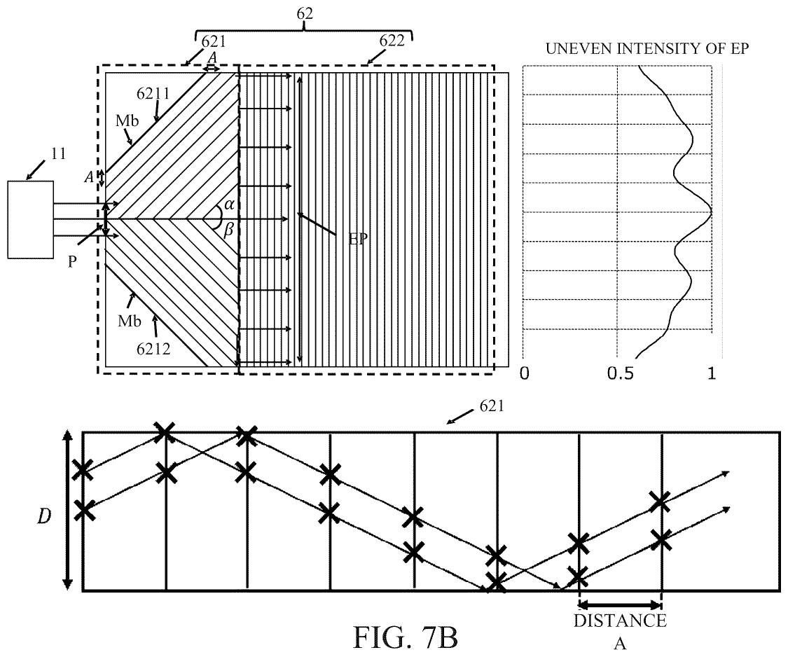

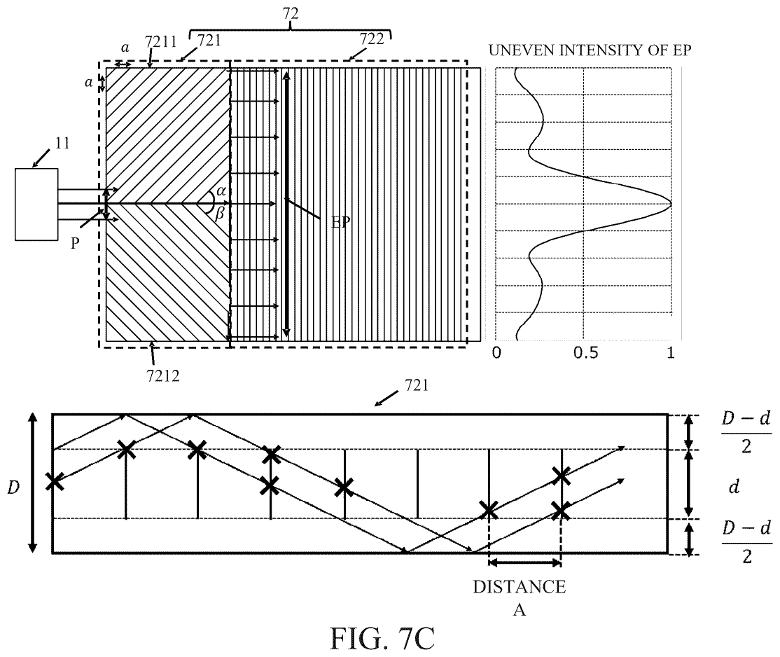

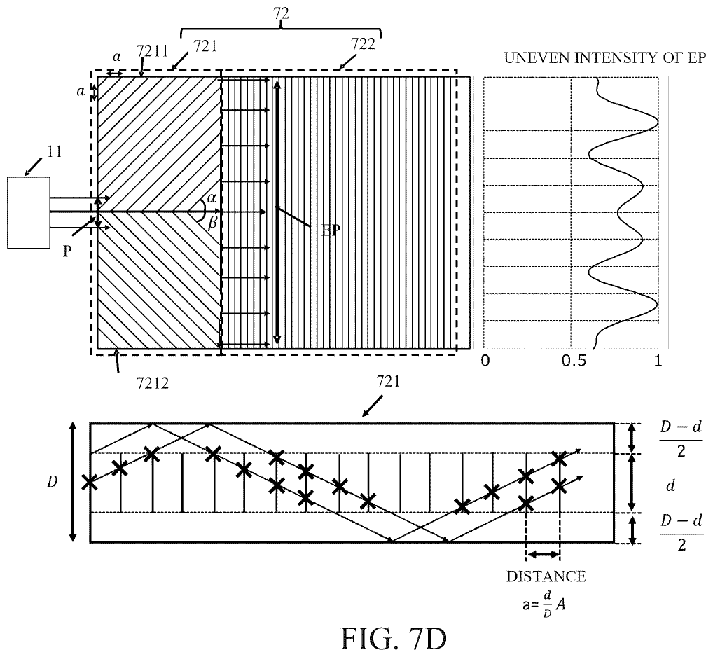

Next, a fourth embodiment of the disclosure will be described with reference to FIGS. 7A, 7B, 7C, and 7D. FIG. 7A is a schematic diagram of a light guide plate (light guide element) 72 according to this embodiment. FIG. 7B illustrates an optical path in the thickness direction of the light guide plate 62 according to the third embodiment and the intensity of the expanded light beam. FIGS. 7C and 7D illustrate the optical path in the thickness direction of the light guide plate 72 according to this embodiment and the intensity of the expanded light beam.

The first to third embodiments assume that the width of the mirror in the expander for the thickness direction of the light guide plate is equal to the thickness of the light guide plate. On the other hand, this embodiment will discuss the configuration of the expander in a case where the width of the mirror is narrower than the thickness of the light guide plate. Such an expander is applied, for example, in a case where mirrors cannot be formed throughout the thickness direction due to manufacturing constraints and the like, such as a manufacturing method using injection molding.

First, with reference to FIG. 7A, the light guide plate 72 according to this embodiment will be described. The light guide plate 72 includes an expander 721 and an emitter 722. The expander 721 includes mirror groups 7211 and 7212 that are arranged at angles α and β on opposite sides of the first direction. Each of the mirror groups 7211 and 7212 has a plurality of adjacent parallel mirrors along each of the first and second directions. The distance between two adjacent mirrors in each of the first and second directions (mirror distance) is set to a. However, this embodiment is not limited to this example, and the mirror distance in each of the first and second directions may be different.

In the direction of thickness D of the light guide plate 72 (thickness direction), the width d of each mirror (partially reflective surface) is smaller than the thickness D of the light guide plate 72. The distance a may satisfy the following inequality (3):

$$a \leq A \cdot d / D \qquad ( 3 )$$

where A is a distance between each mirror in the third embodiment.

FIG. 7B illustrates an optical path of a light ray incident on the expander 621 in the third embodiment, when viewed from the thickness direction of the light guide plate 62. On the other hand, FIGS. 7C and 7D illustrate an optical path of a light ray incident on the expander 721 in this embodiment, when viewed from the thickness direction of the light guide plate 72. FIG. 7C illustrates the case where a=A, and FIG. 7D illustrates the case where a=A·d/D, respectively.

In a case where the value becomes higher than the upper limit of inequality (3), as illustrated in FIG. 7C, the number of reflections by the mirror decreases compared to when the mirror width is equal to the thickness. In this case, a transmitting light amount is large, a reflected and expanded light amount is small, and light amount unevenness of the expanded light beam increases.

On the other hand, as illustrated in FIG. 7D, in a case where the mirror distance is set to satisfy inequality (2), all light rays are reflected at least the same number of times as when the mirror width is equal to the thickness, and the light amount unevenness of the expanded light beam can be suppressed. Thus, reducing the distance between a plurality of partially reflective surfaces can suppress the intensity unevenness and expand the light beam.

In each embodiment, the expander and the emitter may have the same integrally formed surface. That is, there is no layer of air or the like between the expander and the emitter, and the surface of the expander and the surface of the emitter are connected. Since this type of structure can be achieved, for example, by injection molding using two molds, and a light guide plate can be more easily manufactured.

Each embodiment can provide a light guide element, an observation optical system, and a display apparatus, each of which has a reduced size and can suppress the occurrence of ghosts.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-199180, which was filed on Nov. 14, 2024, and which is hereby incorporated by reference herein in its entirety.

What is claimed is:

1. A light guide element comprising:
an expander configured to expand incident light; and
a light guide unit configured to guide light expanded by the expander to an eyepoint,
wherein the expander includes a first reflector and a second reflector,
wherein each of the first and second reflectors has a plurality of reflective surfaces,
wherein in a first cross section including the first and second reflectors, the first and second reflectors form angles with different signs from a first axis corresponding to a principal ray at a central angle of view of the incident light,
wherein in each of the first and second reflectors, a reflective surface of the plurality of reflective surfaces closest to the light guide unit is a partially reflective surface, and
wherein light reflected multiple times by at least one of the first and second reflectors reaches the light guide unit.

2. The light guide element according to claim 1, wherein the plurality of reflective surfaces include a first surface and a second surface that have different reflectances.

3. The light guide element according to claim 1, wherein a reflective surface of the plurality of reflective surfaces farthest from the light guide unit has a reflectance of 90% or more.

4. The light guide element according to claim 1, wherein an absolute value of a first angle of the first reflector relative to the first axis and an absolute value of a second angle of the second reflector relative to the first axis are less than 45°.

5. The light guide element according to claim 1, wherein an absolute value of a first angle of the first reflector relative to the first axis and an absolute value of a second angle of the second reflector relative to the first axis are equal to each other.

6. The light guide element according to claim 1, wherein the following inequalities are satisfied:
$$\begin{matrix}\vert α \vert - \vert φ \vert / 2 < 45 \\ \vert β \vert - \vert φ \vert / 2 < 45\end{matrix}$$
where α (°) is a first angle of the first reflector relative to the first axis, β (°) is a second angle of the second reflector relative to the first axis, and φ (°) is an angle of the incident light relative to the first axis.

7. The light guide element according to claim 1, wherein at least a part of a side surface of the expander is a light shielding surface.

8. The light guide element according to claim 1, wherein the plurality of reflective surfaces include at least three reflective surfaces arranged along the first axis, and
wherein each of the plurality of reflective surfaces except for a reflective surface farthest from the light guide unit is the partially reflective surface.

9. The light guide element according to claim 1, wherein the plurality of reflective surfaces include at least three reflective surfaces arranged along a second direction orthogonal to the first axis, and
wherein each of the plurality of reflective surfaces except for a reflective surface farthest from an incident part of the incident light in the expander is the partially reflective surface.

10. The light guide element according to claim 1, wherein a width of the partially reflective surface in a thickness direction of the light guide element is smaller than a thickness of the light guide element.

11. The light guide element according to claim 1, wherein the expander and the light guide unit have the same integrally formed surface.

12. The light guide element according to claim 1, wherein a reflectance of the partially reflective surface decreases as a distance along the first axis from a projection unit that emits the incident light increases.

13. The light guide element according to claim 1, wherein the plurality of reflective surfaces include a first partially reflective surface and a second partially reflective surface that is closer to the light guide unit than the first partially reflective surface, and
wherein a reflectance of the first partially reflective surface is higher than a reflectance of the second partially reflective surface.

14. The light guide element according to claim 1, wherein the plurality of reflective surfaces include a first partially reflective surface and a second partially reflective surface that is closer to the light guide unit than the first partially reflective surface, and
wherein each of a reflectance of the first partially reflective surface and a reflectance of the second partially reflective surface decreases as a distance from a projection unit that outputs the incident light increases.

15. An observation optical system comprising:
the light guide element according to claim 1; and
a projection unit that outputs the incident light.

16. A display apparatus comprising:
the observation optical system according to claim 15; and
a display element.
